(19) United States
(12) Patent Application Publication
(10) Pub. No.: US 2019/0047483 A1
(43) Pub. Date: Feb. 14, 2019

(54) MOTORCYCLE TIE-DOWN RACK

(71) Applicant: James E. Wilterdink, Runnells, IA (US)

(72) Inventor: James E. Wilterdink, Runnells, IA (US)

(21) Appl. No.: 16/059,394

(22) Filed: Aug. 9, 2018

Related U.S. Application Data
(60) Provisional application No. 62/543,947, filed on Aug. 10, 2017.

(51) Int. Cl. B60R 9/10; B60P 3/079; B60R 9/06; B62H 3/00

(52) U.S. Cl. CPC B60R 9/10; B62H 3/00; B60R 9/06; B60P 3/079

(57) ABSTRACT

A removeable motorcycle rack which can be quickly slipped into two existing stake pocket slots on the opposite sides of the vehicle bed. The rack is then secured with the use of mounting points at the bottom front of bed where a turnbuckle hook is used to secure the rack to the vehicle on each side. Once the motorcycle rack is secured, up to three motorcycles can be mounted securely in the rear of a vehicle. With the use of additional brackets, or stand mounts with stake pockets, the rack can be installed on an open trailer or in an enclosed trailer.

### CROSS REFERENCE TO RELATED APPLICATIONS

This Application is a U.S. Non-Provisional Patent Application claiming priority from U.S. Provisional Patent Application, Ser. No. 62/543,947 filed Aug. 10, 2017 entitled MOTORCYCLE TIE-DOWN RACK, which is incorporated herein by reference in its entirety.

### BACKGROUND OF INVENTION

### Field of the Invention

The present invention is directed to a quick, easy and removeable way of securing motorcycles in the bed of a vehicle or trailer.

### Description of Related Art

When securing motorcycles in the rear of a vehicle currently, tie down straps connect from the motorcycle handlebars or frame to a mounting point in front bottom corners of bed and can cause several issues. When securing from the handlebars to mounting points, downward force compresses the front forks and can damage the fork oil seals. When compressing front tires of the motorcycles they want to move forward and are pressed against the front of the vehicle bed and deform this area over time. If there is more than one motorcycle, the tie down straps may need to be laced thru the front wheels to attach to the mounting points and this can cause spoke damage and makes it difficult to secure several motorcycles without assistance from others.

These concerned with these and other problems recognize the need for an improved motorcycle tie-down system.

### BREIF SUMMARY OF THE INVENTION

The removeable motorcycle rack can be quickly slipped into two existing stake post slots on opposite sides of the vehicle bed. It is then secured with the use of mounting points in the bottom front of bed where a turnbuckle hook is used to secure the rack to the vehicle on each side. Once the motorcycle rack is secured, up to three motorcycles can be securely mounted in the rear of a vehicle. The motorcycle rack can be mounted to a trailer with a specially designed bracket and secured with removable pins.

### BRIEF DESCRIPTION OF THE SEVERAL VIEWS OF THE DRAWINGS

These and other attributes of the invention will become clearer upon a thorough study of the following description of the best mode for carrying out the invention, particularly when reviewed in conjunction with the drawings wherein:

FIG. 1 is a perspective view of the motorcycle tie-down rack of the present invention installed in the cargo bed of a pickup truck;

FIG. 2 is a perspective view of the rack installed on a trailer with a stand bracket to attach the rack to the trailer;

FIG. 3 is a perspective view of the tie-down rack;

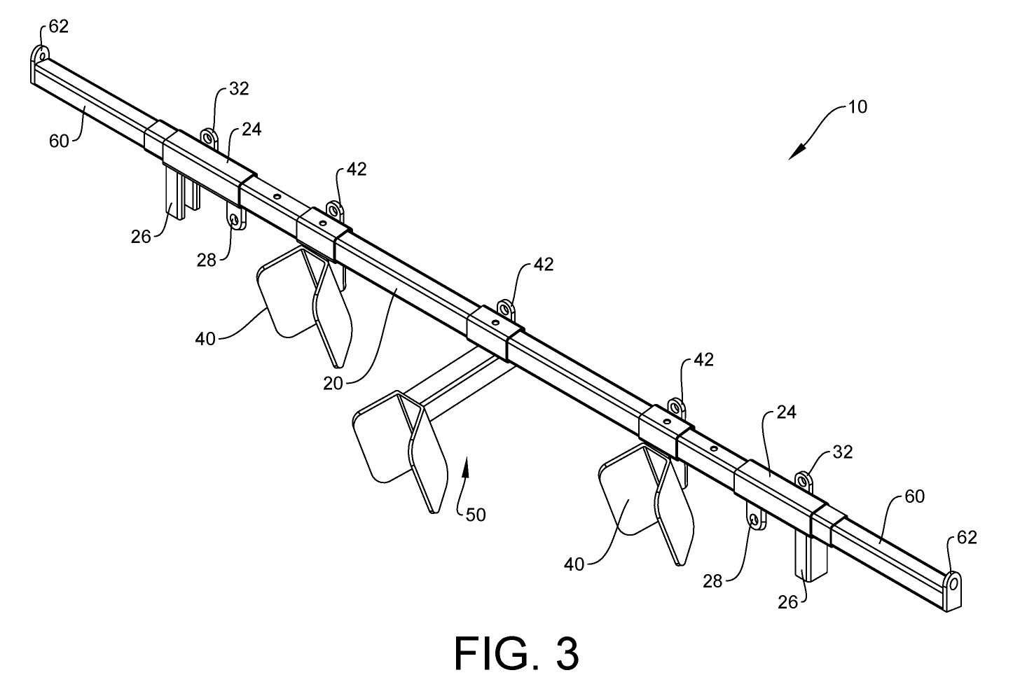

FIG. 4 is a top plan view of the rack;

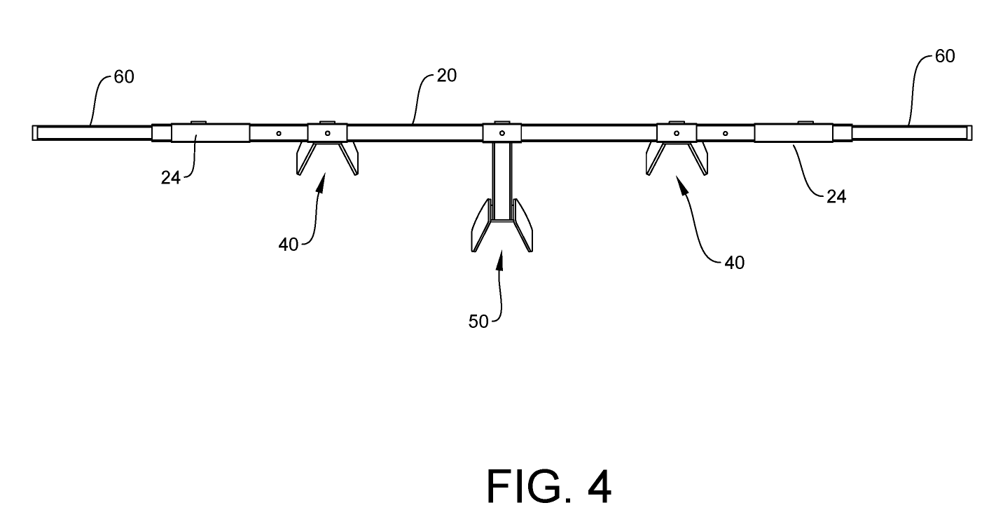

FIG. 5 is a rear elevational view of the rack;

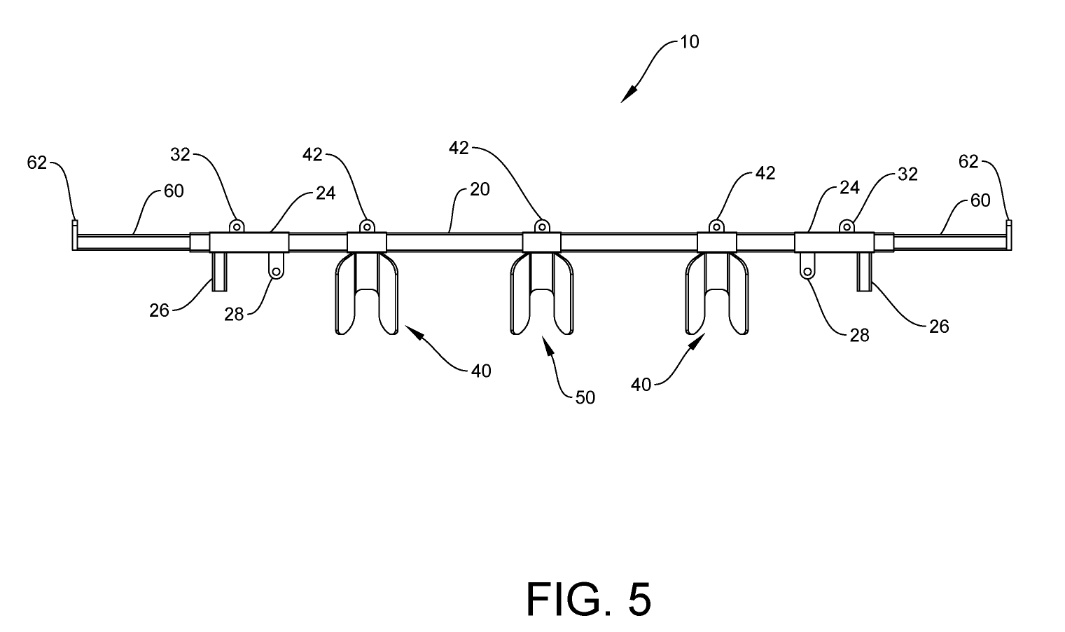

FIG. 6 is a side elevational view of the rack;

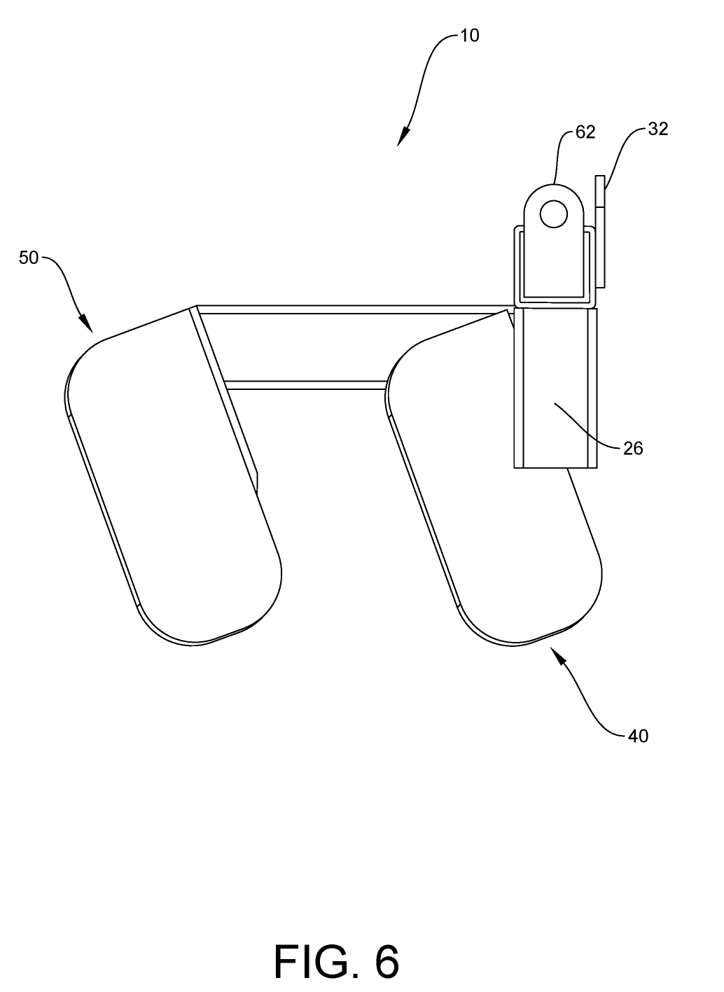

FIG. 7 is a perspective view of the main cross bar;

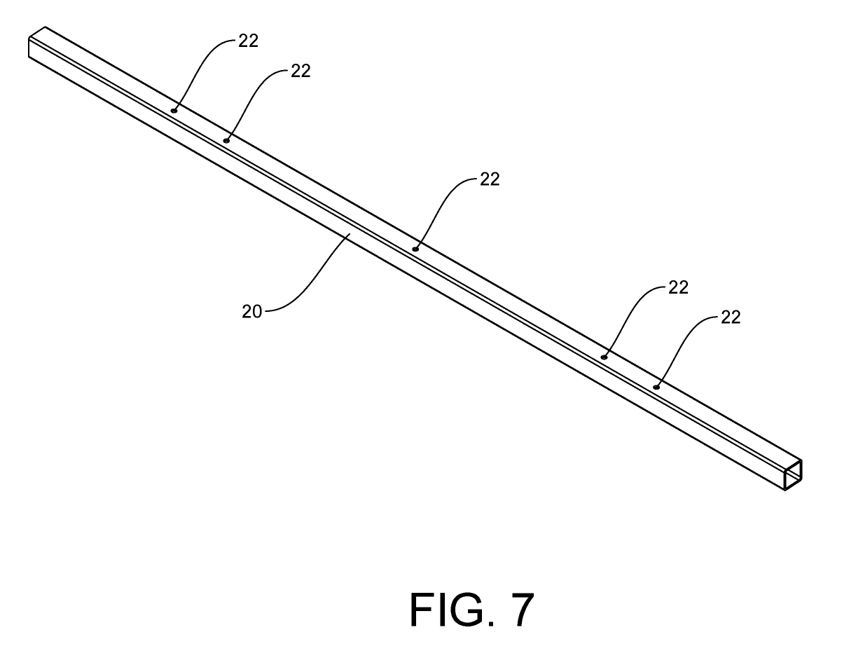

FIG. 8 is a perspective view of the mounting collar;

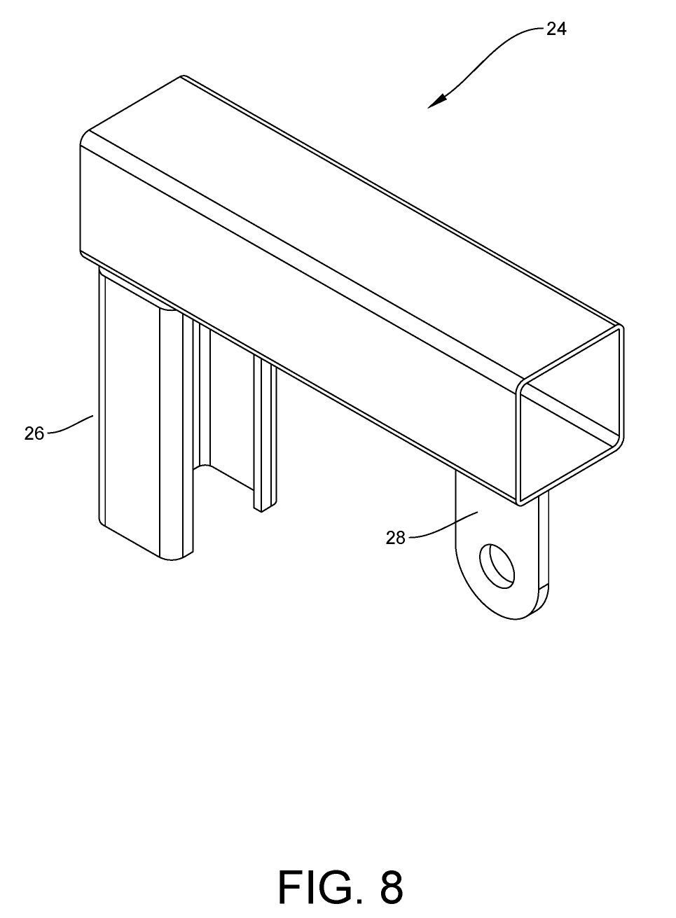

FIG. 9 is a perspective view of the wheel chock;

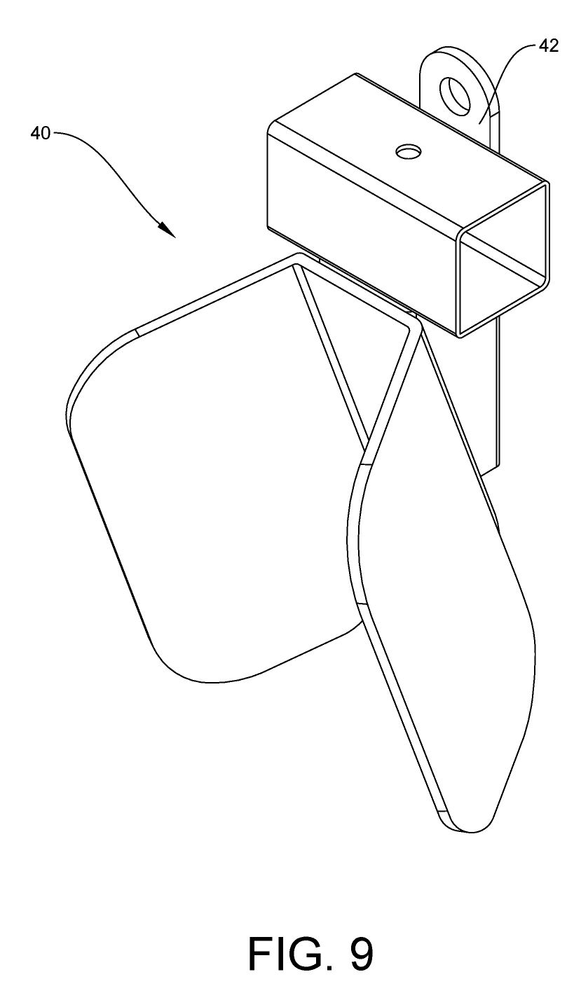

FIG. 10 is a perspective view of the extended wheel chock;

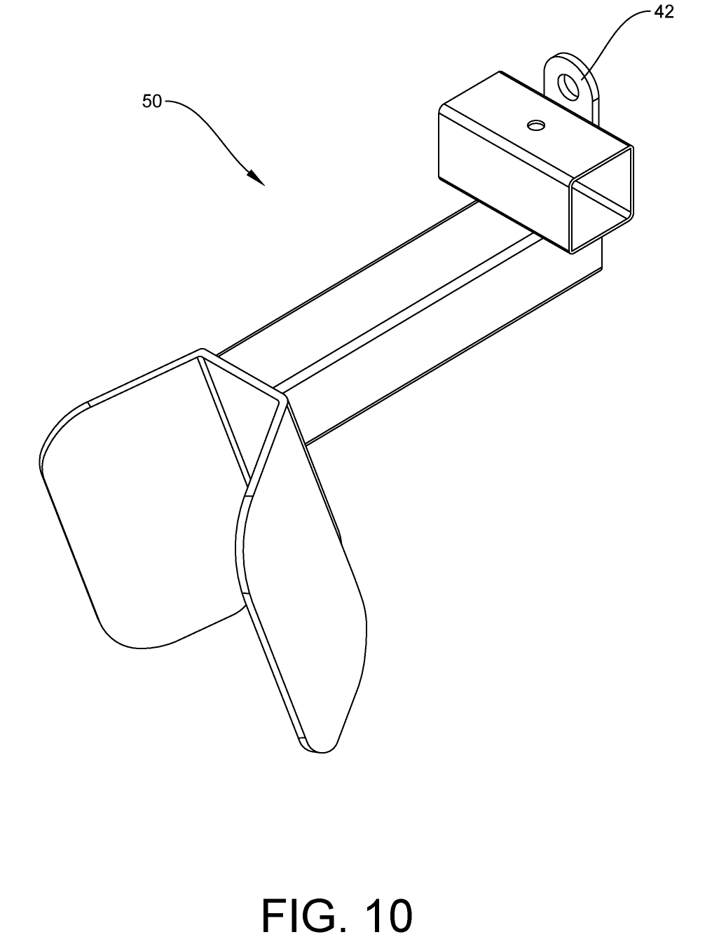

FIG. 11 is a partial perspective view of an end extension in the stowed position; and

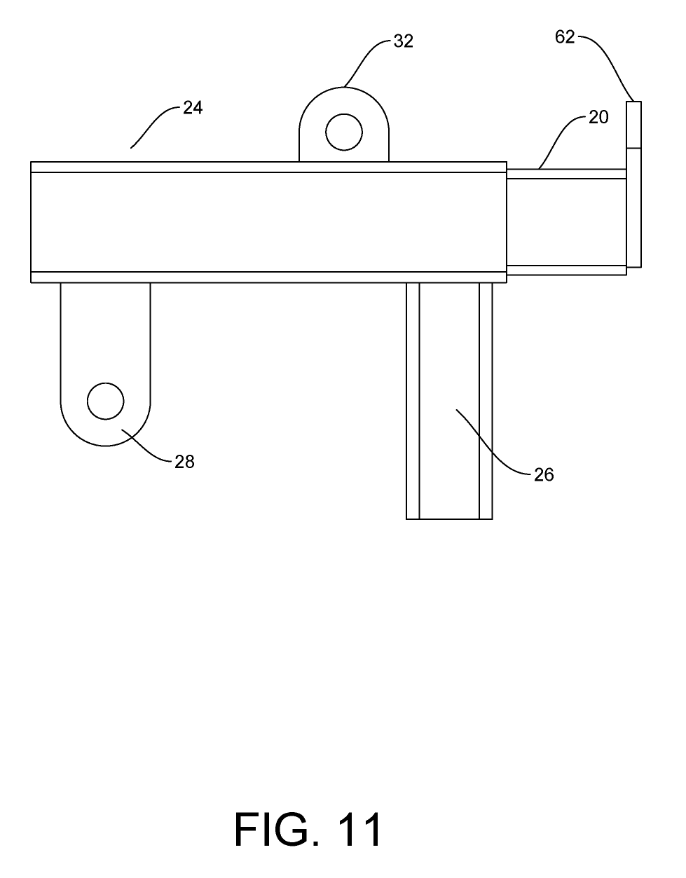

FIG. 12 is a partial perspective view of the end extension in the extended position.

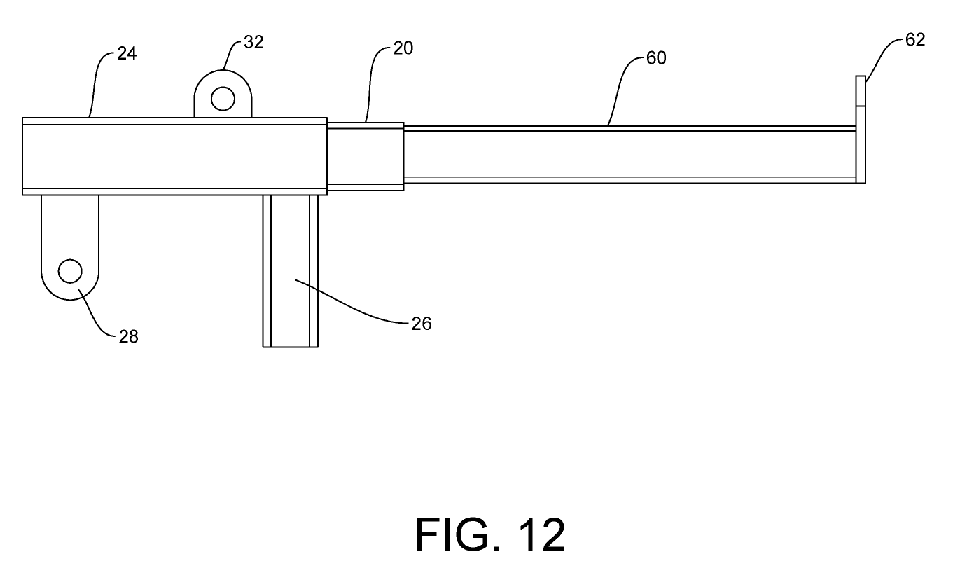

### DETAILED DESCRIPTION OF THE INVENTION

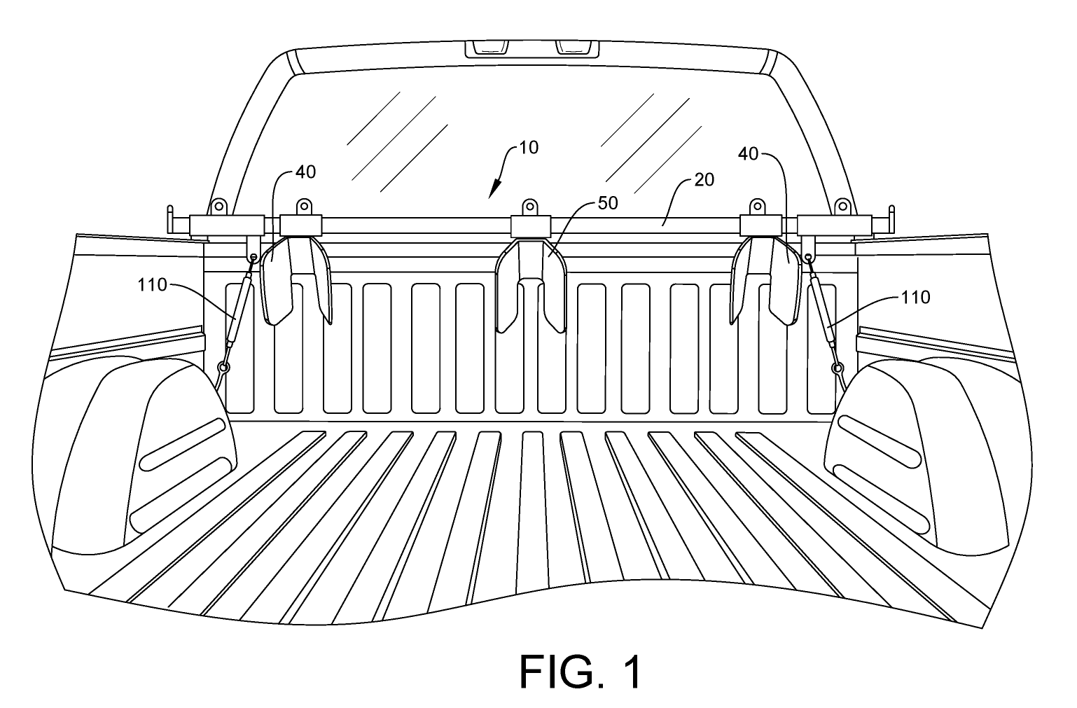

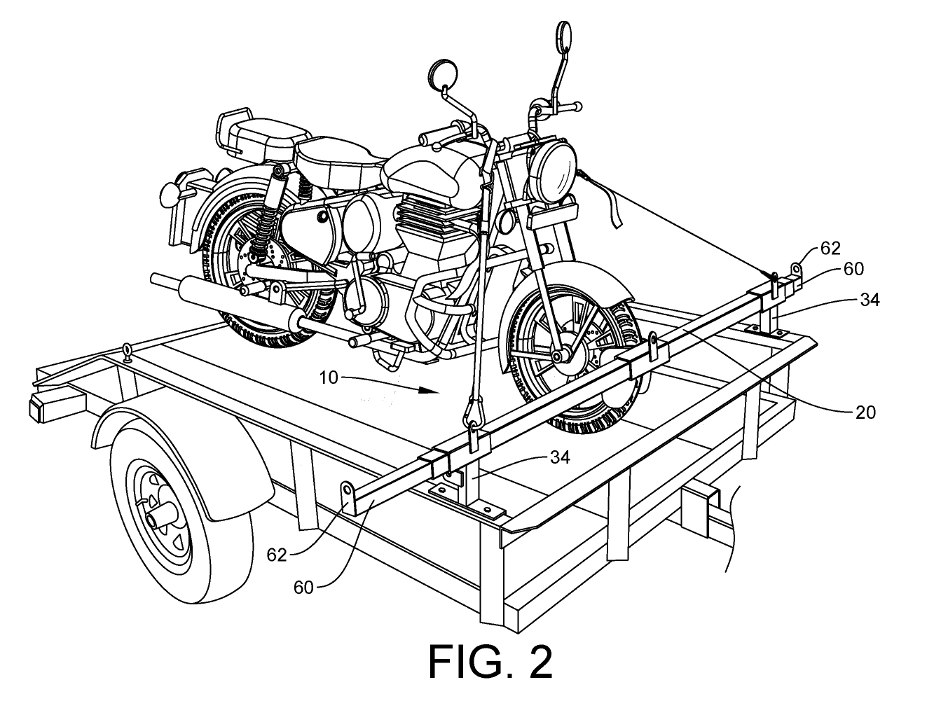

As can be seen by reference to the drawings, and to FIGS. 1 and 2, the motorcycle tie-down rack that forms the basis of the present invention is generally designated by reference numeral 10. The rack 10 includes, a main cross bar 20, wheel chocks 40 and 50, and selectively extendable end extensions 60.

The main cross bar 20 has several guide holes 22 for mounting of the wheel chocks 40 in various locations. The wheel chocks 40 are slid onto the main cross bar 20 and positioned at mounting holes 22 and pinned in place. The wheel chocks 40 have a mounting point 42 at the top to connect a tie down strap 24 to secure a motorcycle. The main cross bar 20 is inserted inside the mounting collar 24. The mounting collar 24 has a down tube 26 that is inserted into the stake pockets on a vehicle, or the stake pocket in the trailer stand bracket 34, to secure the rack 10 from moving in a horizontal plane. The mounting collar 24 also has a mounting point 32 at the top to connect a strap. The mounting collar 24 has a mounting tab 28 located on the underside which is used to connect a turnbuckle 110 to a lower mounting point 28 on the vehicle bed floor area. The turnbuckle 110 secures the rack 10 from moving in a vertical plane. At each distal end of the mounting collar 24 is an end extension 60. These are stored inside the mounting collar 24 and held in place with a pin. Each end extension 60 can be extended outward and pinned in place to provide a more unique and secure mounting point for a tie down strap to secure a motorcycle.

Securing motorcycles involves loading them into the bed of vehicle or trailer and aligning the front tire with the wheel chock 40 mounted on the main cross bar 20. Once the front wheel is pressed against the chock 40, two separate tie down straps can be affixed to the front of the motorcycle on opposite sides and connect the other end to the mounting tabs 62 atop the end extensions 60 or the top tab 42 of a wheel chock 40 in a forty-five-degree angle to the direction the motorcycle's front wheel is facing to provide an adequate stability point while transporting. Three motorcycles can be secured in this manner with the use of the extended wheel chock 50 placed in the center of the main cross bar 20 which helps prevent contact between the motorcycles during transport.

Although only an exemplary embodiment of the invention has been described in the detail above, those skilled in the art will readily appreciate that many modifications are possible without materially departing from the novel teachings and advantages of this invention. Accordingly, all such modifications are intended to be included within the scope of this invention as defined in the following claims.

1. A motorcycle tie-down rack for a vehicle including a cargo bed having a floor and sidewalls with formed stake pockets disposed at opposite sides of the bed, the rack comprising:
a main cross bar disposed to extend across the cargo bed, the cross bar being operably attached to the stake pockets and the floor of the cargo bed; and
a wheel chock operably attached to the extending back from the cross bar, the wheel chock including chock sides disposed the receive a portion of a motorcycle tire.

2. The rack of claim 1, further including a pair of mounting collars, one of the pair of collars being attached to each of the crossbar ends, each of the pair of mounting collars including a finger tab sized to be matingly received in one of the stake pockets.

3. The rack of claim 1, further including a pair of extension bars, one of the pair of extension bars being attached to and extension out from each one of the cross bar ends.

4. The rack of claim 1, wherein the wheel chock is slideably received on the cross bar, and adjustably secured to the cross bar.

5. The rack of claim 4, including a plurality of wheel chocks adjustably secured to the cross bar.

6. The rack of claim 5, wherein one of the plurality of the wheel chocks extends back from the cross bar further than the others.

7. The rack of claim 6, wherein three wheel chocks are attached to the cross bar, and a central of the three wheel chocks extends back from the cross bar further than the others.

8. The rack of claim 1, wherein the chock sides are angled back to receive an upper portion of the motorcycle tire.

9. The rack of claim 3, wherein the extension bars are slideably received in the cross bar and are moveable between a stowed position and an extended position.

10. The rack of claim 1, wherein the vehicle is a trailer, and wherein the stake pocket is formed in brackets attached to opposite sidewalls of the trailer.
